(19) United States
(12) Patent Application Publication
(10) Pub. No.: US 2010/0231549 A1
(43) Pub. Date: Sep. 16, 2010

(54) Liquid crystal display integrated with capacitive touch devices

(75) Inventors: Shun-Ta Chien, Taoyuan County (TW); Heng-Yao Chang, Taoyuan County (TW)

Correspondence Address: PATENT GROUP 2N;JONES DAY, NORTH POINT, 901 LAKESIDE AVENUE, CLEVELAND, OH, 44114, US

(73) Assignee: TPK TOUCH SOLUTIONS INC., Taipei (TW)

(21) Appl. No.: 12/653,359

(22) Filed: Dec. 11, 2009

(30) Foreign Application Priority Data
Mar. 13, 2009 (TW) 098108169

(51) Int. Cl. G06F 3/045; G02F 1/13; G02F 1/1335

(52) U.S. Cl. 345/174; 349/187; 349/96

(57) ABSTRACT

A liquid crystal display integrated with a capacitive touch device is provided. A first electrode layer is formed immediately on an upper surface of a polarizing plate of a liquid crystal display panel, and a second electrode layer is formed on the bottom surface of the polarizing plate of the liquid crystal display panel. When an object touches the capacitive touch device, it becomes capacitively coupled to the first electrode layer and the second electrode layer to generate a signal corresponding to the touched position.

### FIELD OF THE INVENTION

The present invention relates to a liquid crystal display integrated with a touch device. More specifically, it relates to a liquid crystal display integrated with a capacitive touch device.

### BACKGROUND OF THE INVENTION

Liquid crystal displays (LCD) with various designs are commonly used by people. Please refer to FIG. 1 and FIG. 2. FIG. 1 is a sectional view of a conventional liquid crystal display panel, and FIG. 2 is a sectional view of a liquid crystal display module. As shown in the figures, the liquid crystal display panel 1 comprises a liquid crystal display module 10 and a protective layer 11 attached thereon.

The liquid crystal display module 10 includes a lower polarizing plate 12, a lower substrate 101, a lower conductive layer 102, a liquid crystal layer 103, an upper conductive layer 104, a color filter 13, an upper substrate 105 and an upper polarizing plate 14.

The industry has developed certain technologies for the integration of liquid crystal display panel and touch device, which can make the operation easier. In early stage, the touch device comprises resistance films. When an object touches the surface of the touch device, a stress generated by the object brings the two resistance films into physical contact, so that a switch is turned on and a touch signal is sent to a controller for processing to determine the touched position. However, after long-term usage, the resistance films are prone to damages caused by frequent pressing and it becomes hard to precisely determine the touched position.

In order to overcome the above mentioned defects of the designs that utilized resistance films, a capacitive touch device has developed. A capacitive touch device comprises two touch sensing layers and a medium layer arranged between the two touch sensing layers. In conventional manufacturing processes, the liquid crystal display panel and the capacitive touch device are produced separately, and then subsequently stacked and attached together. A user can use a conductive object such as a finger or stylus to select the icons shown on the surface of the touch device to operate or to input data.

### SUMMARY OF THE INVENTION

However, it is required to separately attach a protective layer to the surface of the touch device and that of the liquid crystal display panels. The protective layers are primarily made of glass. As a result, the use of two protective layers requires the consumption of a large amount of materials for manufacturing. In addition, as described above, touch devices and liquid crystal displays are separately manufactured, and then subsequently stacked and adhered together. Such an assembly process is complicated and time consuming, and also tends to produce defective products. Moreover, the products manufactured in this way will inherently have a greater thickness, which makes it difficult to further slim down the whole device.

It is an object of the present invention to provide a liquid crystal display with an integrated capacitive touch device that does not require additional substrates. In this way, further reduction in device thickness can be achieved.

The liquid crystal display of the present invention, in one embodiment, comprises a liquid crystal display panel, a first electrode layer and a second electrode layer. The liquid crystal display panel comprises a liquid crystal display module comprising an upper polarizing plate and a lower polarizing plate. The first electrode layer comprises an electrode pattern (e.g., a predetermined electrode pattern) formed on a surface, such as the top surface, of the upper polarizing plate. The second electrode layer comprises an electrode pattern formed on the bottom of the upper polarizing plate.

In another embodiment, a liquid crystal display and a capacitive touch sensing layer that is capable of sensing touch movement in a first and a second direction, such as X-axis movement and Y-axis movement, are included. The capacitive touch sensing layer is formed immediately on a surface, such as the top or bottom surface, of the upper polarizing plate.

By means of the present invention, a liquid crystal display as described can be integrated with a capacitive touch device without using extra substrates. The present invention enables an integrated capacitive touch device be made slimmer and lighter. More particularly, the liquid crystal display is directly integrated with capacitive touch device in a simpler manufacturing process instead of being assembled together after separate manufacturing processes. It has many advantages such as a simpler manufacturing process, a higher yield rate, and a lower manufacture cost. In addition, because the electrode layer is attached, e.g., to the top of the upper polarizing plate of the liquid crystal display and is closer to the finger or other touch object, the electrode layer's touch-sensing ability is improved.

### BRIEF DESCRIPTION OF THE DRAWINGS

FIG. 1 is a sectional view of a conventional liquid crystal display panel;

FIG. 2 is a sectional view of a conventional liquid crystal display module;

FIG. 3 is a sectional view in accordance with a first embodiment of the present invention;

FIG. 4 is an exploded view showing the first embodiment of the present invention;

FIG. 5 is a exploded view showing a second embodiment of the present invention;

FIG. 6 is a exploded view showing a third embodiment of the present invention;

FIG. 7 is a sectional view of a portion of a capacitive touch sensing layer; and

FIG. 8 is an exploded view showing a fourth embodiment of the present invention.

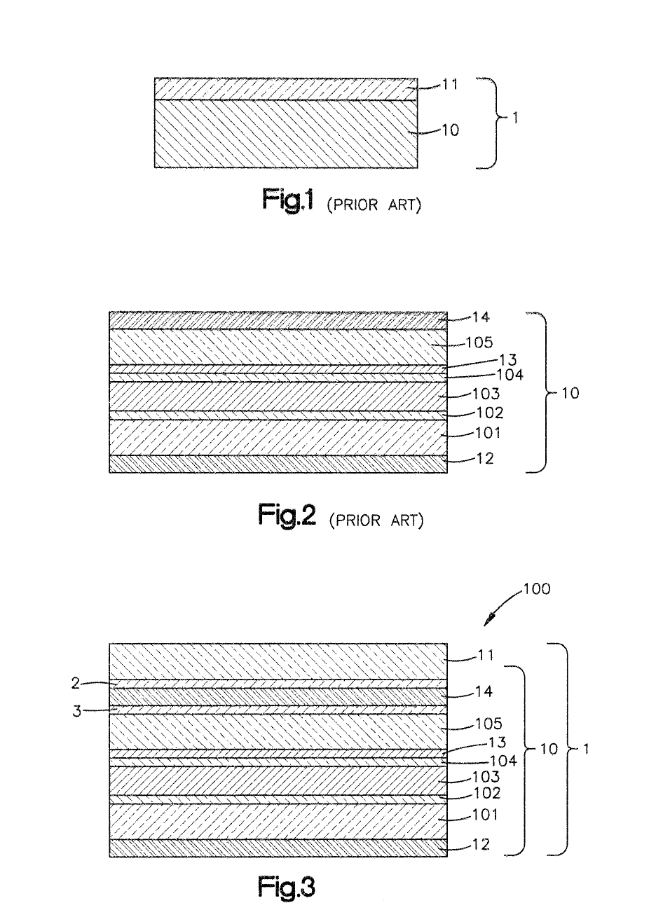

### DETAILED DESCRIPTION OF THE EMBODIMENTS

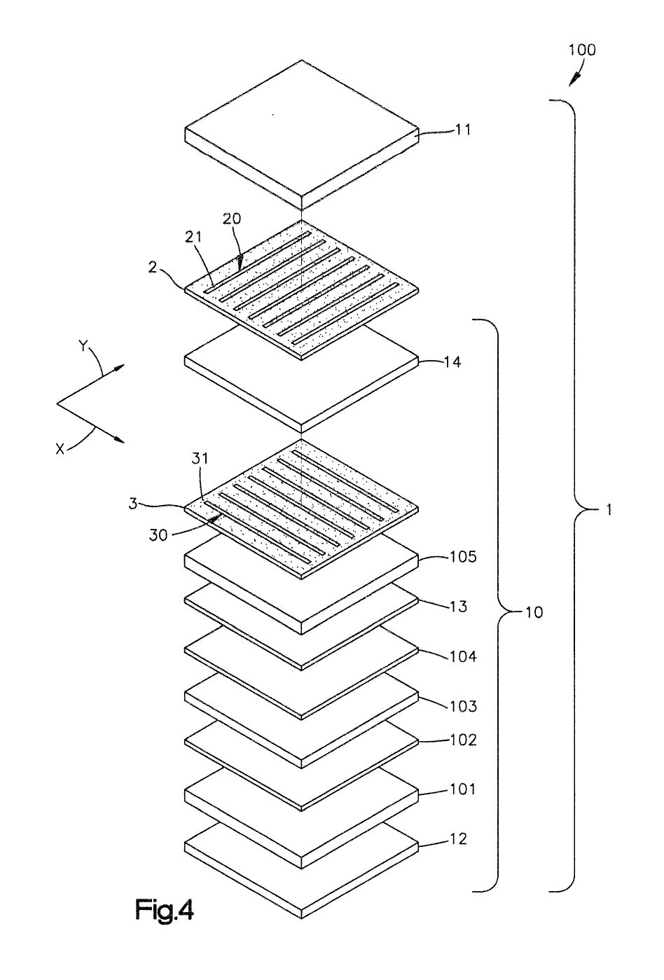

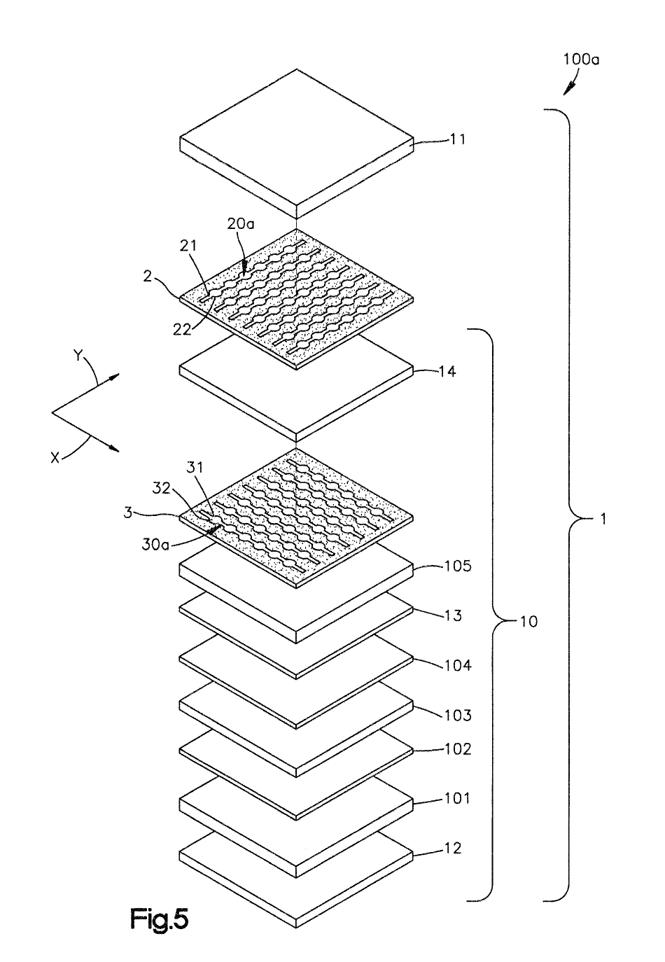

Please refer to FIG. 3, which is a sectional view of a first embodiment of the present invention. As shown in FIG. 3, the liquid crystal display 100 of the present invention includes a liquid crystal display panel 1, a first electrode layer 2, and a second electrode layer 3.

The liquid crystal display panel 1 comprises a lower polarizing plate 12, a lower substrate 101, a lower conductive layer 102, a liquid crystal layer 103, an upper conductive layer 104, a color filter 13, an upper substrate 105, an upper polarizing plate 14 and a protective layer 11. The color filter 13 includes a black matrix and a color resist.

The first electrode layer 2 is formed immediately on top of the upper polarizing plate 14; and the second electrode layer 3 is formed immediately on the bottom of the upper polarizing plate 14.

FIG. 4 is an exploded view showing the first embodiment of the present invention. As shown in the figure, the first electrode layer 2 has an electrode pattern 20 including a plurality of electrode strips 21, and the electrode strips 21 are substantially parallel to and spaced from each other. Similarly, the second electrode layer 3 has an electrode pattern 30 that includes a plurality of electrode strips 31, and the electrode strips 31 are substantially parallel to and spaced from each other. The electrode strips 21 of the first electrode layer 2 and the electrode strips 31 of the second electrode layer 2 are electrically coupled with a controller (not shown in the figure).

According to the first embodiment, the electrode strips 21 of the first electrode layer 2 are arranged in a direction substantially perpendicular to that of the electrode strips 31 of the second electrode layer 3. The electrode strips 21 of the first electrode layer 2 is configured to sense a touch movement in a first direction, such as axis Y, and the electrode strips 31 of the second electrode layer 3 is configured to sense a touch movement in a second direction, such as axis X. It is apparent that the electrode strips 21 of the first electrode layer 2 can be configured to sense a touch movement in axis X, and the electrode strips 31 of the second electrode layer 3 is configured to sense a touch movement in axis Y.

The electrode strips 21 and 31 can have different shapes. For example, the electrode strips can have shapes of diamond, square, or hexagon. As shown in FIG. 5, a plurality of hexagonal electrodes 22 is connected to form an electrode strip of the electrode pattern 20a of the first electrode layer 2. Similarly, a plurality of hexagonal electrodes 32 is connected to form an electrode strip of the electrode pattern 30a of the second electrode layer 3.

The first electrode layer 2 and the second electrode layer 3 of the liquid crystal display are electrically coupled with the controller (not shown in figure). When a user touches the liquid crystal display (e.g., direct contact with a finger or indirect contact via a conductive object), the object is separately and capacitively coupled to the first electrode layer 2 and the second electrode layer 3, so that, e.g., a touch signal corresponding to the X-axis coordinate and Y-axis coordinate of the touched position is generated and the signal is sent to the controller for further processing to determine the touched position.

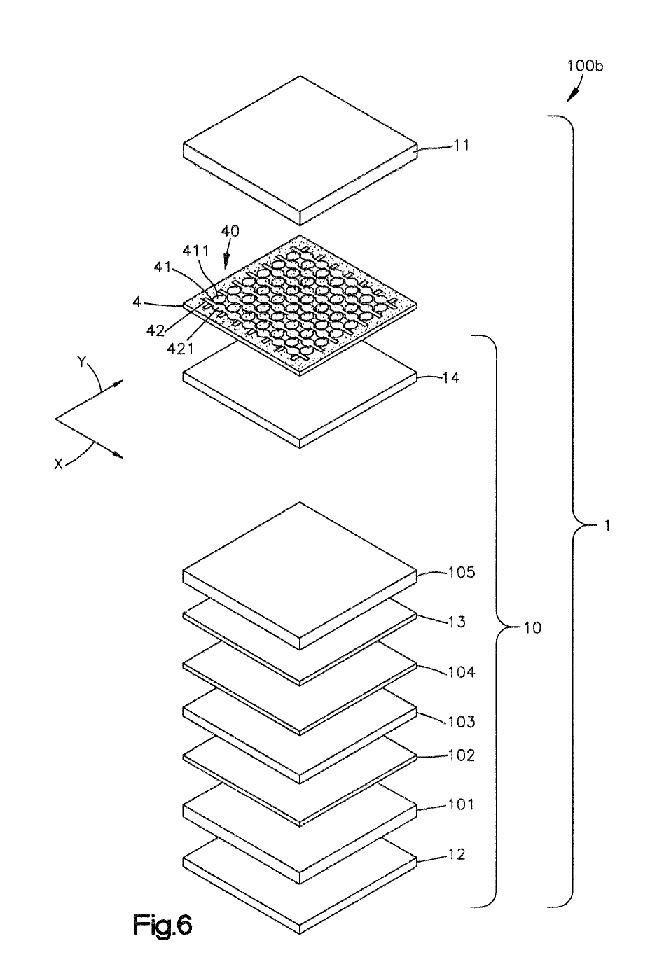

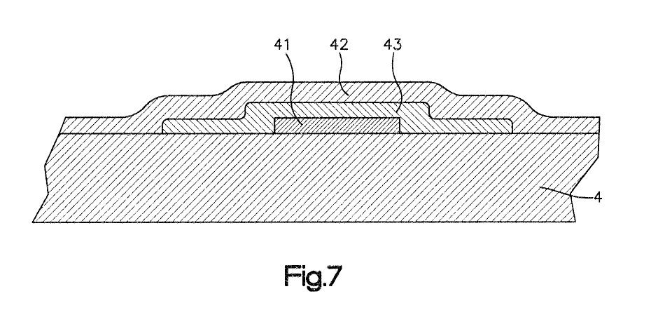

Please refer to FIGS. 6 and 7. FIG. 6 is an exploded view showing a third embodiment of the present invention and FIG. 7 is a sectional view of a portion of a capacitive touch sensing layer. The third embodiment is similar to the first embodiment mentioned above. However, the difference between the two embodiments is that the third embodiment includes a capacitive touch sensing layer 4 formed on a top of the upper polarizing plate 14.

The capacitive touch sensing layer 4 comprises an electrode pattern 40, which comprises a plurality of first electrode strips 41 and second electrode strips 42. The first electrode strips 41 are arranged in a direction substantially perpendicular to that of the second electrode strips 42. The second electrode strips 42 overlap on the first electrode strips 41, but the first and second electrode strips are not in direct physical contact. An insulating layer 43 is formed on the first electrode strips 41 at where the second electrode strips 42 overlap the first electrode strips 41 (as shown in FIG. 7), so that the second electrode strips 42 avoid direct physical contact with the first electrode strips 41. Each first electrode strip 41 is formed by a string of connected hexagonal electrodes 411 and each second electrode strip 42 is formed by a string of connected hexagonal electrodes 421. Due to the hexagonal shape, the first electrodes 41 and second electrodes 42 can effectively increase touch sensitivity.

When a user touches a capacitive touch device as described in the present invention with an object (e.g., a finger or a conductive object), the object is separately and capacitively coupled to the first electrode 41 and the second electrode 42, so that a touch signal according to the touched area size and corresponding to the X-axis and Y-axis coordinate of touched position is generated and sent to the controller for further signal processing to determine the touched position (not shown in diagram).

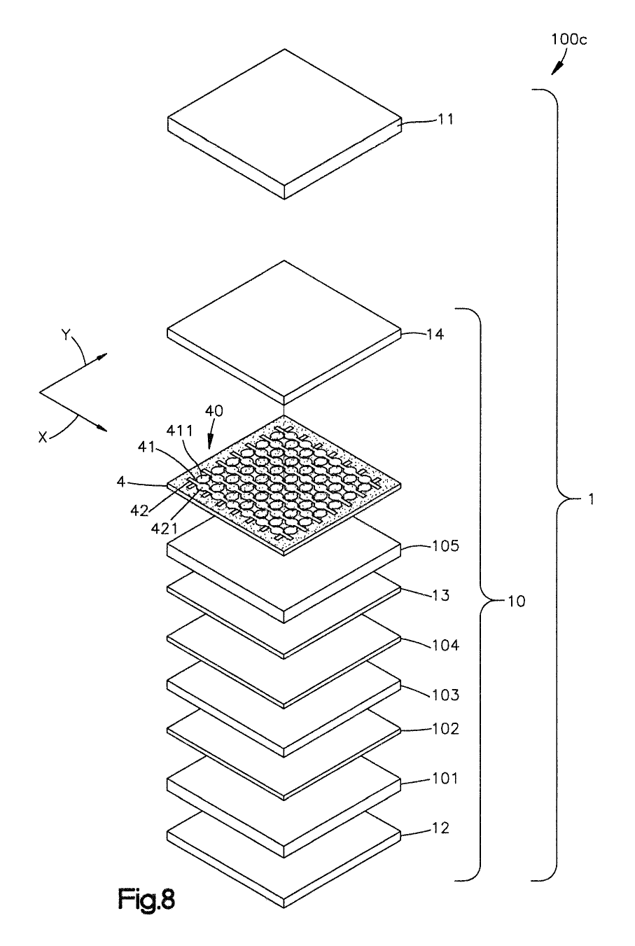

FIG. 8 is an exploded view according to a fourth embodiment of the present invention. The fourth embodiment is similar to the third embodiment mentioned above. However, the difference between the two embodiments is that the fourth embodiment comprises a capacitive touch sensing layer 4 formed on the bottom of the polarizing plate 14. Similarly, when touching the liquid crystal display with an object, the object is separately and capacitively coupled to the first electrode 41 and the second electrode 42 to generate a signal corresponding to the touched position.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. An integrated capacitive touch device, comprising:
a liquid crystal display module comprising a polarizing plate, wherein the polarizing plate has an upper surface and a lower surface;
a first electrode layer having an electrode pattern, wherein the first electrode layer is formed immediately on the upper surface of the polarizing plate; and
a second electrode layer having an electrode pattern, wherein the second electrode layer is formed immediately on the lower surface of the polarizing plate.

2. The liquid crystal display as claimed in claim 1, wherein the electrode pattern of the first electrode layer and the second electrode layer comprises a plurality of electrode strips.

3. The liquid crystal display as claimed in claim 2, wherein each electrode strip of the first electrode layer and the second electrode layer comprises a plurality of electrically connected hexagonal electrodes.

4. The liquid crystal display as claimed in claim 1, further comprising an additional polarizing plate.

5. An integrated capacitive touch device, comprising:
a liquid crystal display module comprising a polarizing plate; and
a capacitive touch sensing layer situated immediately adjacent to the polarizing plate.

6. The liquid crystal display as claimed in claim 5, wherein the capacitive touch sensing layer has an electrode pattern.

7. The liquid crystal display as claimed in claim 6, wherein the electrode pattern of the capacitive touch sensing layer comprises a plurality of first electrode strips and a plurality of second electrode strips, the first electrode strips being arranged in a direction substantially perpendicular to that of the second electrode strips and overlap the second electrode strips, and wherein the first electrode strips are not in direct physical contact with the second electrode strips.

8. The liquid crystal display as claimed in claim 7, wherein each electrode strip of the first electrode layer and each electrode strip of the second electrode layer are separately formed of a plurality of electrically connected diamond-shaped electrodes.

9. An integrated capacitive touch device, comprising:
a liquid crystal display module comprising a polarizing plate; and
a capacitive touch sensing layer formed directly on the bottom surface of the polarizing plate, wherein the capacitive touch sensing layer includes first electrode strips for sensing movement in a first direction and second electrode strips for sensing movement in a second direction, and wherein the first electrode strips and the second electrode strips are not in direct physical contact.

10. An integrated capacitive touch device, comprising:
a liquid crystal display module comprising a polarizing plate; and
a capacitive touch sensing layer formed directly on the top surface of the polarizing plate, wherein the capacitive touch sensing layer includes first electrode strips for sensing movement in a first direction and second electrode strips for sensing movement in a second direction, and wherein the first electrode strips is not in direct physical contact with the second electrode strips.

11. An integrated capacitive touch device, comprising:
a liquid crystal display module comprising a polarizing plate, wherein the polarizing plate has a first surface and a second surface; and
an electrode layer having an electrode pattern in immediate physical contact with the polarizing plate.

12. The integrated capacitive touch device of claim 11, wherein the electrode layer is in immediate physical contact with the first surface of the polarizing plate.

13. The integrated capacitive touch device of claim 11, wherein the electrode layer is in immediate physical contact with the second surface of the polarizing plate.

14. The integrated capacitive touch device of claim 11, wherein the electrode layer is configured to sense touch movement in a first direction and touch movement in a second direction.

15. The integrated capacitive touch device of claim 14, wherein the electrode layer senses touch movement in a first direction via first electrode strips and touch movement in a second direction via second electrode strips, and wherein the first electrode strips and second electrode strips are substantially perpendicular.

16. The integrated capacitive touch device of claim 11, further comprising an additional electrode layer, wherein the electrode layer is configured to sense touch movement in a first direction, and the additional electrode layer is configured to sense touch movement in a second direction.

17. The integrated capacitive touch device of claim 16, wherein the electrode layer is in immediate physical contact with the first surface of the polarizing plate, and wherein the additional electrode layer is in immediate physical contact with the second surface of the polarizing plate.

18. A liquid crystal display integrated with a capacitive touch device, comprising:
a liquid crystal display panel, comprising a liquid crystal display module, the liquid crystal display module comprising an upper polarizing plate and a lower polarizing plate;
a first electrode layer, having a predetermined electrode pattern formed on a top of the upper polarizing plate; and
a second electrode layer, having a predetermined electrode pattern formed on a bottom of the upper polarizing plate, wherein when an object touches the liquid crystal display, the object is capacitively coupled to the first electrode layer and the second electrode layer respectively, and the position touched by the object is determined.

19. A method for producing a liquid crystal display integrated with a capacitive touch device, comprising:
providing a liquid crystal display module comprising a polarizing plate; and
forming a capacitive touch sensing layer immediately on the polarizing plate.

20. A method of manufacturing a liquid crystal display integrated with a capacitive touch device, comprising:
providing a liquid crystal display module comprising a polarizing plate, wherein the polarizing plate has an upper surface and a lower surface;
forming a first electrode layer having an electrode pattern immediately on the upper surface of the polarizing plate; and
forming a second electrode layer having an electrode pattern immediately on the lower surface of the polarizing plate.
